(19) United States
(12) Patent Application Publication
(10) Pub. No.: US 2015/0226612 A1
(43) Pub. Date: Aug. 13, 2015

(54) BOLOMETRIC DETECTOR WITH A MIM STRUCTURE INCLUDING A THERMOMETER ELEMENT

(71) Applicant: COMMISSARIAT A L'ENERGIE ATOMIQUE ET AUX ENE ALT, Paris (FR)

(72) Inventors: Ujwol PALANCHOKE, Grenoble (FR); Salim BOUTAMI, Grenoble (FR); Jean-Louis OUVRIER-BUFFET, Sevrier (FR); Jean-Jacques YON, Sassenage (FR)

(73) Assignee: COMMISSARIAT A L'ENERGIE ATOMIQUE ET AUX ENE ALT, Paris (FR)

(21) Appl. No.: 14/617,042

(22) Filed: Feb. 9, 2015

(30) Foreign Application Priority Data
Feb. 12, 2014 (FR) 14 51091

(51) Int. Cl. G01J 5/20; G01J 5/02

(52) U.S. Cl. CPC G01J 5/20; G01J 5/02

(57) ABSTRACT

A bolometric detector including at least:
a substrate;
a membrane suspended above the substrate by support elements;
an absorber element comprising at least one MIM structure formed by a lower metal element, an upper metal element and a dielectric element arranged between the lower metal element and the upper metal element;
a thermometer element comprising at least one thermometric material;
wherein the membrane includes at least the upper metal element of the MIM structure and the thermometric material, and wherein the thermometric material is part of the dielectric element of the MIM structure.

### TECHNICAL FIELD AND PRIOR ART

The invention relates to the thermal detectors, and more precisely that of non-cooled thermal detectors such as resistive type bolometric detectors. Bolometric detectors according to the invention are advantageously used to detect wavelengths in the infrared domain.

To perform a detection in the infrared domain, a non-cooled thermal infrared detector generally includes a sensitive element the temperature of which increases when the same receives an infrared radiation the wavelength of which belongs for example to the band III (between 8 and 12 μm) which is characteristic of the temperature and emissivity of the elements observed by this detector type. The increase in temperature of the sensitive element generates a variation of an electrical property of the material of this sensitive element: appearance of electric charges in the material of the sensitive element by pyroelectric effect, variation in the capacitance of the material of the sensitive element by a change in its dielectric constant, variation in the electrical resistance of the semi-conductor or metal material of the sensitive element, etc.

To achieve a high performance of such a thermal infrared detector, the material of the sensitive element should meet three main conditions: it should have a low heat capacity, a good thermal insulation of the active layer (which includes the sensitive element) from its support (both these conditions implying making the sensitive element as a thin film) and finally a strong sensitivity of the conversion effect of the material warming into an electrical signal.

Monolithic infrared imagers operating at room temperature are for example manufactured by directly connecting an array of sensitive elements to a CMOS- or CCD-type silicon multiplexing circuit.

For a better performance, the thermal infrared detector can be encapsulated under vacuum or in an atmosphere comprising a low heat conductive gas.

The casing wherein the thermal infrared detector is encapsulated then includes a transparent window to the infrared radiation intended to be detected by the thermal infrared detector.

In a resistive type bolometric detector, the incident radiation is absorbed by the sensitive element of the detector, which causes an increase in its temperature and induces a variation in the electrical resistance of the sensitive element of detector. This variation in resistance generates a variation in voltage or current at the terminals of the detector, forming the signal outputted by the detector.

FIGS. 1 and 2 respectively show a perspective view and a top view of a thermal detector of electromagnetic radiations 1, that is a bolometer. This type of detector 1 includes a thin membrane 10 suspended above a support substrate 13. This membrane 10 includes a first layer of material forming the absorber element of the detector 1 and a second layer of material forming the thermometer element of the detector 1. Other detectors, analogous to that shown in FIGS. 1 and 2, are generally present on the support substrate 13. The membrane 10 is mechanically suspended above the substrate 13 through support elements 11 to which are attached thermally insulating arms 12 which are mechanically connected to the membrane 10.

Under the effect of the incident radiation received by the detector 1, the first layer of the membrane 10 forming the absorber element becomes warm and transmits its temperature to the second layer of the membrane 10 forming the thermometer element. According to the state of the art, different types of thermometer element are possible among which the thermistor is a widely spread option. The support substrate 13 includes an electronic circuit integrated on a silicon wafer, this circuit comprising on the one hand stimuli and reading devices of the thermometer element of each of the detectors 1, and on the other hand multiplexing components which allows to place in series the signals coming from the different thermometer elements to a reduced number of outputs such that these signals can be operated by a usual imaging system.

The sensitivity of the thermal detectors is notably improved by virtue of the presence of the thermally insulating arms 12 in the thermal link between the support substrate 13 and the membrane 10, these arms enabling the thermal losses of the membrane 10 to be restricted and consequently its warming to be preserved. The electrical interconnection between the thermometer element of the detector 1 and the elements for reading the electronic circuit is insured by an electrically conductive layer, generally of metal, which is arranged on the thermally insulating arms 12, and by the support elements 11 which are electrically conductive.

The sensitive material (absorber element) of the membrane 10 can be a semi-conductor material such as polycrystalline or amorphous silicon, of the p or n type, of low or high resistivity. It can also be a vanadium oxide (V₂O₅ or VO₂) made in a semi-conducting phase. Generally, the sensitive material lays on an insulating support of the membrane 10, for example comprising SiO₂, SiO, SiN, or ZnS, which insures the mechanical rigidity of the membrane 10. It can also be wholly encapsulated with one of these insulating materials. Different assessments show that the vanadium oxide based compounds have a better performance in terms of TCR (temperature coefficient of resistance) and 1/f noise than metal materials as platinum or other conventional semi-conductor materials as amorphous silicon or amorphous germanium or compounds thereof. However, there are other materials having a high temperature coefficient.

Since the size of an imager is set by the cost of the component and optics, the only way to increase the spatial resolution of an imager of a given size is to reduce the pitch with which the detectors of this imager are made. But with constant technology and architecture, the reduction of the area of the detector generates a decrease in the thermal resolution of the detector mainly because of the response degradation (sensitivity) of the detector. In conjunction with the improvement of the performances of the thermometric material, the thermal resistance and the fill factor of the detectors should also be increased or at least kept at a high performance level.

In practice, the system is optimized when the pitch of the unit detector is between about 1 to 2 times the average wavelength intended to be detected. This approach presupposes a fill factor close to 100% which is always search for in the field of bolometers because out of construction, there is no intermodulation possibility by the substrate (cross linking of the detectors). Thus, for a detector device operating in the 8-14 μm band, the pitch of the detectors can be reasonably reduced up to about 10 μm.

Besides the reduction in the pitch, there are also significant perspectives in terms of arrays of bolometric detectors selective in wavelength with the integration of metal selective filters/absorbers directly on the detector, without inserting a spectral filter between the scene and the detector. Document “Spectral selectivity in infrared thermal detection” of Joseph J. Talghader et al., Light: Science & Application (2012) shows different developments in this field. These improvement perspectives (reduction in the pitch, selective absorption of the radiation) should however not be achieved at the expense of the thermal time constant of these detectors.

Periodic metal structures can be used as filters in the infrared range.

These filters can be logically introduced on the optical way upstream of the bolometric structure. Another possibility is to make a selective absorption directly at the bolometric panel as described in document FR 2 941 297. In this alternative, periodic metal patterns are directly made on the bolometric panel and correspond to the thermometer material of the detector. The presence of a metal periodic structure consisting on the one hand of anchoring structures (nails) and on the other hand of patterns integrated on the panel and in the thermal insulation system makes a reflecting filter enabling electromagnetic radiations to be detected according to some wavelengths. A localized conversion of the semi-conducting thermometric material (semi-conducting ferrite) into a metal material (iron) having a strong conductivity thus enables a further function to be added to the detectors without modifying the method for manufacturing the bolometric detectors. The filter characteristics are determined by the pitch of the patterns and their dimensions. The patterns can be circles, squares, triangles, crosses.

According to the pitch of the pixel and the wavelength to be reflected, some patterns should be split into two parts. As long as the cut-off between these parts is of a very small dimension relative to the wavelength, the operation of the filter is not altered.

The proportion of semi-conductor material converted into metal material is between 25% and 50% of the semi-conductor material initially deposited. But, this results in a significant change in the current lines in the thermometer material by constriction effect, and thus to introduce further low frequency noise. Further, the conversion of the semi-conductor material into metal material which should be performed restricts the materials useable to make this type of structure: it is for example not possible to use amorphous silicon.

The documents “Wavelength-tunable microbolometers with metamaterial absorbers” by Thomas Maier and Hubert Brückl, OPTICS LETTERS/Vol 34, No. 19/Oct. 1, 2009, and “Multispectral microbolometers for the midinfrared” by Thomas Maier and Hubert Brückl, OPTICS LETTERS/Vol 34, No. 19/Nov. 15, 2010, describe a metal periodic structure arranged on the bolometric panel. The selective absorption is performed in the MIM type metamaterial (that is corresponding to a metal-insulator-metal type stack) made above the bolometric panel. At identical thermal resistance, this configuration has however the drawback of increasing the thermal time constant by at least a factor 2, thus restricting the pick-up frequency that can be obtained with such detectors. This approach is thus no longer compatible with an operation in imager mode (for example to perform the follow-up of a chemical product cloud escaping from an industrial site). It is mentioned in these documents that the presence of the continuous metal film in the entire membrane and thus also in the insulating arms enables to keep the heat capacity of the detector constant by reducing the thermal resistance. This approach, difficult to implement from a technological point of view, results in a degradation of the signal-to-noise ratio (that is an increase in NEDT, “Noise Equivalent Differential Temperature”) by a factor of at least 2.

Document FR 2 977 937 A1 describes a bolometric detector comprising a centred MIM structure having dimensions reduced with respect to the total area of the detector. The reduction in the size of the absorber element thus leaves a greater area to develop the thermally insulating arms of the detector. This type of detector has the characteristic to be selective and of a small pitch. However, this structure also generates an increase in the thermal time constant of the detector, which restricts the pick-up frequency that can be obtained with this type of detector.

The material making up the thermometer element of a detector is nearly always the source of low frequency noise. This comes from its manufacture made at a low temperature because of the “above IC” approach widely used in the field. Thus, to reduce its impact on performance in terms of NEDT, there is a trend towards increasing its volume and thus the heat capacity of the bolometric panel.

The thermal time constant of bolometric detectors is determined by the product of thermal resistance and heat capacity. Its specification results from “system considerations”. This is a requirement at the design level (CAD, technology). In practice, to arbitrate between the thermal resistance and the heat capacity of the detector is to favour the signal at the expense of the noise level or reversely. On the other hand, it is more relevant to increase the thermal resistance than the volume of the material making the detector.

Furthermore, to incorporate a further structure on the membrane in order to obtain a particular function, as for example a selective absorption of some wavelengths, results inevitably in a degradation of one of the parameters making the performance of bolometric detectors, that is the thermal time constant or the noise level.

### DISCLOSURE OF THE INVENTION

Thus there is a need to provide a new type of bolometric detector which is selective to wavelengths intended to be detected and which is optimized in terms of low frequency noise and thermal time constant, which can be made with a great number of materials, and the thermal time constant of which is compatible with an operation of the bolometric detector in imager mode.

For this, one embodiment provides a bolometric detector including at least:
a substrate;
a membrane suspended above, or facing, the substrate by support elements;
an absorber element comprising at least one MIM structure formed by a lower metal element, an upper metal element and a dielectric element arranged between the lower metal element and the upper metal element;
a thermometer element comprising at least one thermometric material;

wherein the membrane includes at least the upper metal element of the MIM structure and the thermometric material, and wherein the thermometric material is part of the dielectric element of the MIM structure.

The dielectric element of the MIM structure can correspond to an element comprising at least one portion of insulating or semi-conductor material, having an electrical resistivity higher than about 0.1 Ω·cm and a permittivity the value of the real part of which is positive and the value of the imaginary part of which is lower than about 20%, or lower than about 10%, of that of the real part at a wavelength for which the absorption efficiency of the bolometric detector is maximum.

The bolometric detector thus allows making an absorbing structure by using the thermometric material as a constituent element of the absorber element which includes one or more MIM (Metal-Insulator-Metal) type structures in order to make efficient selective bolometric imagers. Thus, by using the thermometric material to form a part of the dielectric element of the MIM structure, the bolometric detector has a good thermal time constant which is compatible with a use of the bolometric detector within an imager. Moreover, the MIM structure(s) of the bolometric detector enable(s) a good selectivity which is further readily parameterisable according to the characteristics with which the MIM structures are made to be obtained. Finally, the structure of such a bolometric detector does not restrict the choice of usable materials to form the absorber element of the detector, which is not detrimental to the performances of such a bolometric detector because of the low frequency noise which remains low.

Such a bolometric detector is suitable for detecting wavelengths belonging to the band III, that is between about 8 μm and 12 μm.

The term “MIM structure” designates herein a stack including at least one dielectric element arranged between an upper metal element and a lower metal element, and able to perform a selective absorption of some wavelengths depending on its dimensions and the materials of the structure.

The MIM structure is able to perform a selective absorption of wavelengths intended to be detected by the bolometric detector by exciting plasmon resonances at these wavelengths.

The MIM structure may have a selectivity concerning wavelengths such that a full width at half maximum of the absorption curve of the MIM structure is less than λ/10, with λ corresponding to the wavelength for which the absorption of the MIM structure is maximum.

The MIM structure may be such that the upper and lower metal elements have reflection capabilities which are substantially equal, that is such that impedances R1 and R2 of these two metal elements are such that 0.1*R1<R2<10*R1, with R1 and R2 expressed as Ω per square.

The thermometric material may include an electrical resistivity higher than about 0.1 Ω·cm and a permittivity a value of the real part of which is positive and a value of the imaginary part of which is lower than about 20%, or lower than about 10%, of that of the real part at a wavelength for which the absorption efficiency of the bolometric detector is maximum. Thus, the thermometric material may be a semi-conductor such as a-Si, a-SiGe, vanadium oxide, FeO or Fe₃O₄, more generally a metal oxide.

A distance between the lower metal element and the upper metal element may be lower than or equal to about λ/(4 n), or advantageously equal to about λ/(10 n), with λ corresponding to a wavelength for which the absorption efficiency of the bolometric detector is maximum and n corresponding to the actual refractive index of the MIM structure.

According to a first embodiment, the membrane may include the lower metal element of the MIM structure. In this configuration, the MIM structure is formed wholly by the membrane of the bolometric detector.

In this case, the bolometric detector may further include a reflector arranged on the substrate, and a reflective cavity formed between the reflector and the lower metal element of the MIM structure such that a distance between the reflector and the lower metal element of the MIM structure is equal to about half a wavelength for which the absorption efficiency of the bolometric detector is maximum.

According to another embodiment, the lower metal element of the MIM structure may be arranged on the substrate such that an empty space being part of the dielectric element of the MIM structure is arranged between the membrane and the lower metal element. In this configuration, the membrane only forms a part of the MIM structure of the bolometric detector.

The membrane may further include a first dielectric layer electrically insulating the upper metal element from the thermometric material, and a second dielectric layer electrically insulating the thermometric material from the lower metal element, and the first dielectric layer and the second dielectric layer may be part of the dielectric element of the MIM structure.

The absorber element may include several MIM structures each including an upper metal element distinct from the upper metal elements of the other MIM structures, and wherein the thermometric material is common to the MIM structures.

In this case, each MIM structure may include a lower metal element distinct from the lower metal elements of the other MIM structures, or the MIM structures may include a lower metal element common to all the MIM structures.

The thermometric material may be electrically connected to an electronic circuit of the substrate by at least one electrically conductive layer of the membrane and by the support elements.

The membrane may be mechanically and electrically connected to the support elements by thermally insulating arms. These thermally insulating arms may be formed by materials present in the membrane.

Another embodiment relates to a thermal detection device including several bolometric detectors such as described above, said bolometric detectors being arranged as an array.

The bolometric detectors may be arranged by forming several sub-arrays, the bolometric detectors of each of said sub-arrays may be able to detect a range of wavelengths different from those intended to be detected by the bolometric detectors of the other sub-arrays.

The array may include at least one thresholding bolometric detector including a membrane suspended above the substrate and thermally connected to the substrate.

The array may include at least one reference bolometric detector not including a MIM structure.

### BRIEF DESCRIPTION OF THE DRAWINGS

The present invention will be better understood upon reading the description of exemplary embodiments given by way of indicating purposes purely and in no way limiting making reference to the appended drawings wherein:

FIGS. 1 and 2 schematically show a thermal infrared detector according to prior art;

FIGS. 3A and 3B respectively show a profile cross-section view and a schematic top view of a bolometric detector according to a first embodiment;

FIG. 4 shows the absorption efficiency as a function of the wavelength of a bolometric detector according to the first embodiment;

FIGS. 5 and 6 schematically show a profile cross-section view of a bolometric detector respectively according to a second and a third embodiment;

FIG. 7 schematically shows a part of a multispectral detection device according to a particular embodiment.

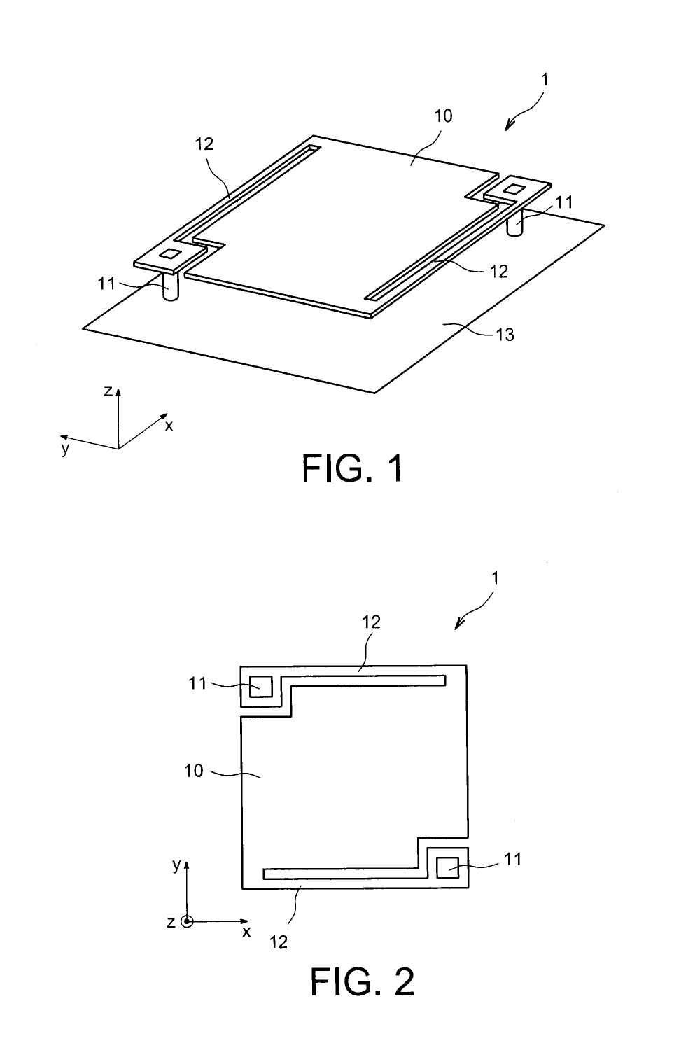

Identical, similar or equivalent parts of the different figures described herein after bear the same reference numerals so as to facilitate switching from one figure to the other.

Different parts shown in the figures are not necessarily drawn at a uniform scale, to make the figures more legible.

The different possibilities (alternative and embodiments) should be understood as being not exclusive from each other and can be combined with each other.

### DETAILED DISCLOSURE OF PARTICULAR EMBODIMENTS

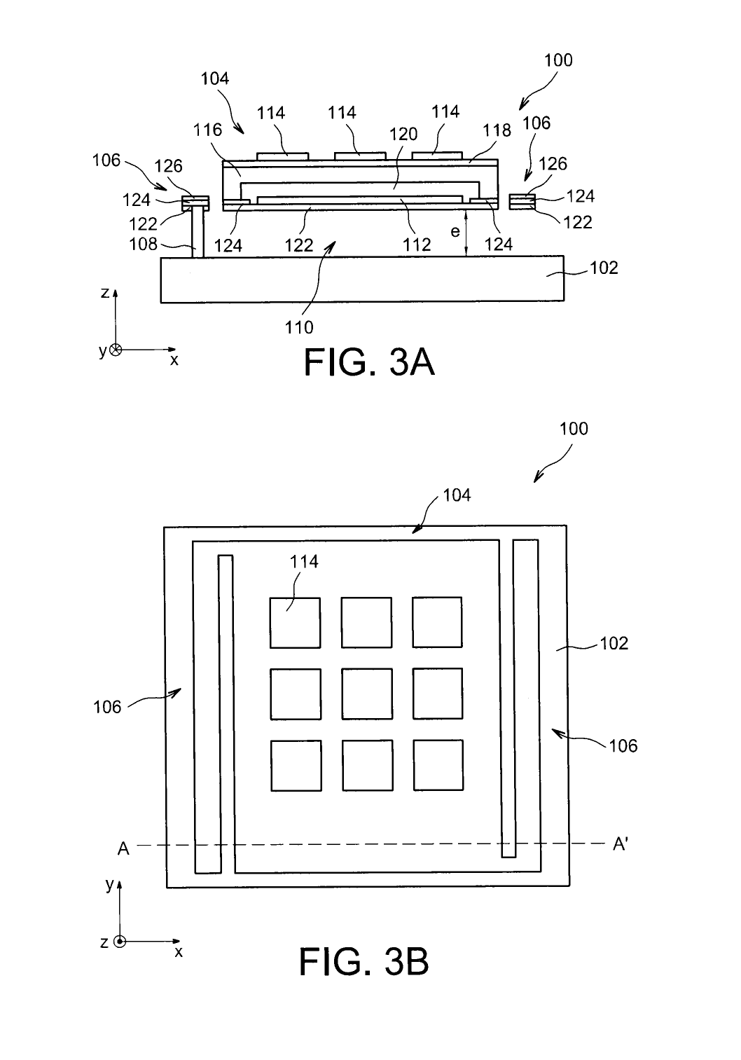

FIGS. 3A and 3B will be first referred to, which respectively show a profile cross-section view and a top view of a bolometric detector 100, or infrared thermal detector, according to a first embodiment. The profile cross-section view shown in FIG. 3A is made along an axis AA′ shown in FIG. 3B. The bolometric detector 100 corresponds to a bolometer or micro-bolometer intended to perform detection in the infrared domain, in particular in the band III that is a detection of wavelengths between about 8 μm and 12 μm.

The bolometric detector 100 includes a substrate 102, including for example a silicon wafer, or slice, forming a mechanical support for the bolometric detector 100. The substrate 102 includes in particular an integrated electronic circuit (non-visible in the FIGS. 3A and 3B) enabling the bolometric detector 100 to be electrically powered and also the signals outputted by the bolometric detector 100 to be read. This electronic circuit can also include a multiplexing circuit enabling signals outputted by several bolometric detectors 100, similar to that shown in FIGS. 3A and 3B, made above the substrate 102, to be processed. Each bolometric detector 100 corresponds to a pixel of a detection array formed above the substrate 102 and which is electrically connected to the electronic circuit.

The bolometric detector 100 includes a membrane 104 suspended above, or facing, the substrate 102 via thermally insulating arms 106 to which the membrane 104 is mechanically connected and via support elements 108, forming anchoring pads, or nails, insuring the mechanical support of the membrane 104 and the thermally insulating arms 106 above the substrate 102. An empty space 110, forming a cavity with a thickness e (this thickness corresponding to the dimension between the membrane 104 and the substrate 102) is present between the substrate 102 and the membrane 104, as well as between the substrate 102 and the thermally insulating arms 106. The thermal insulation between the membrane 104 and the substrate 102 is insured by the thermally insulating arms 106 as well as by the empty space 110.

The membrane 104 includes elements forming both the absorber element and the thermometer element of the bolometric detector 100. The absorber element is formed by several MIM structures made side by side, advantageously as a two-dimension array of N MIM structures. In the example of FIGS. 3A and 3B, the membrane 104 includes 9 MIM structures arranged as a 3×3 array. Alternatively, it is for example possible to have an array of 4×4 or 5×5 MIM structures. Generally, the membrane 104 includes a number N of MIM structures between 1 and 25.

Each of the MIM structures includes a lower metal element 112, made as a portion of a metal layer which, in the first embodiment, is common to all the MIM structures of the membrane 104, which enables the selective absorption made by the MIM structures of the bolometric detector 100 to be maximized. Each of the MIM structures also includes an upper metal element 114. Each upper metal element 114 has herein a square-shaped cross-section, in a plane parallel to a face of the substrate 102 facing the membrane 104 (parallel to the plane (X, Y) in the FIGS. 3A and 3B).

Alternatively, the shape of the upper metal elements 114 could be different, for example round, rectangular, triangular, cruciform, etc. The metal elements 112 and 114 comprise advantageously one or more materials used for the interconnections of the integrated circuits, such as for example aluminium, tungsten, copper, titanium, etc.

Relative to an absorber element which would be formed by a single MIM structure, the use of several upper metal elements 114 to form several MIM structures allows not only to improve the selectivity of the detection made by the bolometric detector 100, but also to pick up more light, that is improve the absorption efficiency of the bolometric detector 100, because of the greater quantity of incident light which is filtered/absorbed thanks to the greater number of MIM structures.

The thicknesses of the lower metal element 112 and the upper metal elements 114 are low in order not to increase the heat capacity of the membrane 104, and are further higher than about 2 times the skin thickness of the materials used. The thicknesses (dimensions along the axis Z) of the metal elements 112 and 114 are for example between about 40 nm and 100 nm. Further, to avoid these metal elements 112 and 114 making non-selective absorption of wavelengths, the metal elements 112 and 114 advantageously include a sheet resistance lower than about 1 Ohm/square.

Finally, the MIM structures also include, between the lower metal element 112 and the upper metal elements 114, dielectric elements enabling the MIM structures to excite plasmon resonances at given wavelengths intended to be detected by the bolometric detector 100, thus providing a good spectral selectivity to the bolometric detector 100. The plasmon resonances occur sideways (in the plane (X, Y)) in the dielectric elements of the MIM structures, facing the upper metal elements 114, as in a Fabry-Pérot type cavity.

These dielectric elements comprise a thermometric material 116 both acting as a thermometer element of the bolometric detector 100 and as a dielectric element, or insulator, of the MIM structures which together form the absorber element of the bolometric detector 100. The thickness (dimension along the axis Z) of the thermometric layer 116 is for example between about 20 nm and 300 nm. The dielectric elements of the MIM structures are also formed by a first dielectric layer 118, herein common to all the MIM structures and which also plays the role of electrical insulator between the upper metal elements 114 and the thermometric material 116, and thus between the thermometer element and the absorber element of the bolometric detector 100, as well as a second dielectric layer 120 which further plays the role of an electrical insulator between the lower metal element 112 and the thermometric material 116. The first dielectric layer 118 and the second dielectric layer 120 each correspond to a dielectric layer or a stack of several very thin dielectric layers, the thickness of which is for example between about 5 nm and 100 nm, or between about 5 nm and 20 nm, and including for example SiO₂, ZnS or SiN in order to insure the best electrical insulating possible between the thermometric material 116 and the metal elements 112 and 114. The material(s) and thickness(es) of these dielectric layers 118, 120 are also selected such that these layers are transparent or of weakly absorbing to wavelengths intended to be detected by the bolometric detector 100.

The values of the wavelengths which are detected depend in particular on the dimensions, in the plane (X, Y), and the period (or pitch) of the upper metal elements 114 of the MIM structures. The lateral dimension, or the dimension of a side, of an upper metal element 114 defines the wavelength for which the absorption carried out by the MIM structure comprising this element is maximal. For example, when the dimension of a side of a MIM structure varies by 0.1 μm (more or less), then the wavelength for which the absorption is maximum varies by 1 μm (more or less). Thus, each of the upper metal elements 114 can include, in the plane (X, Y), dimensions (corresponding for example to the dimensions of the sides or the diameter, according to the shape of the elements) equal to about λ/(2 n), with λ corresponding to the wavelength for which the absorption efficiency of the bolometric detector 100 is maximum, and n corresponding to the actual refractive index of the MIM structure and the value of which is close to the average refractive index of the layers comprised between the metal elements of the MIM structure, or an odd multiple of λ/(2 n). When a variation of more or less 0.2 μm is allowed for the position of the maximum value of the absorption carried out by the MIM structure, the value λ/(2 n) or that corresponding to an odd multiple of λ/(2 n) chosen for the lateral dimensions of the MIM structure, and especially those of the upper metallic element 114, can varies by 0.02 μm (more or less). Moreover, the upper metal elements 114 can be arranged side by side with a period lower than λ.

In each of the MIM structures, the total thickness of the dielectric elements arranged between the upper metal element 114 and the lower metal element 112, that is the sum of the thicknesses of the first dielectric layer 118, the second dielectric layer 120 and the thermometric material 116, and which corresponds to the distance between the metal elements 112 and 114, is lower or equal to about λ/(4 n). Advantageously, this total thickness of the dielectric elements of the MIM structures is lower than or equal to about λ/(10 n).

The detector 100 further includes a third dielectric layer 122 which is common to the membrane 104 and to the thermally insulating arms 106, and on which is provided an electrically conductive layer 124 which is also common to the membrane 104 and to the thermally insulating arms 106. The electrically conductive layer 124, which comprises for example Ti, TiN or Pt, has for example a thickness between about 5 nm and 100 nm and has a sheet resistance between about 100 and 1 000 Ohm per square. The third dielectric layer 122 comprises for example SiO₂ or SiON, and includes a thickness for example between about 5 nm and 50 nm. Finally, dielectric portions 126 cover portions of the electrically conductive layer 124 located in the thermally insulating arms 106. The material and the thickness of the dielectric portions 126 are for example similar to those of the third dielectric layer 122.

In the membrane 104, portions of the electrically conductive layer 124 are in electrical contact with the thermometric material 106, thus allowing the membrane 104 to be electrically powered and the produced detection signals to be read. Moreover, in the thermally insulating arms 106, portions of the electrically conductive layer 124 are in electrical contact with the support elements 108. Thus, because the support elements 108 comprise an electrically conductive material, such as for example Al, Cu or WSi, and are electrically connected to the input stage of the electronic circuit integrated to the substrate 102, and because the portions of the electrically conducting layer 124 of the membrane 104 and the thermally insulating arms 106 form a continuous electrical link, the thermometric material 116 is electrically connected to the integrated electronic circuit of the substrate 102 via the support elements 108 and the electrically conductive layer 124.

The materials and thicknesses of the elements forming the membrane 104 are also selected such that the membrane 104 has a high mechanical strength above the substrate 102 in order to prevent the membrane 104 from bending.

In the bolometric detector 100, the thermometric material 116 is advantageously used both as a thermometer element of the bolometric detector 100 and as a dielectric element of the absorber element of the bolometric detector 100, within the MIM structures of the bolometric detector 100. These MIM structures provide a great selectivity of the wavelengths detected by the bolometric detector 100, this selectivity being readily adjusted via the selection of the dimensions, and thus also of the number, of the MIM structures present in the membrane 104. For the thermometric material 116 to be able to fulfil both these functions, it is advantageously selected from materials the electrical resistivity of which is higher than or equal to about 0.1 Ohm·cm and the dielectric constant, or permittivity of which, at the wavelength for which the absorption efficiency of the bolometric detector 100 is maximum, has a positive real part and a zero or very low imaginary part with respect to the real part, for example lower than about two tenth (20%) or one tenth (10%) of the real part. Thus, the thermometric material 116 is for example an amorphous or polycrystalline semi-conductor such as Si, a-Si, a-Si:H, Ge, a-Ge, a-Ge:H, SiGe, a-SiGe, a-SiGe:H, SiC, a-SiC, a-SiC:H, or vanadium oxide, FeO, Fe₃O₄, or more generally a metal oxide. These examples of materials have all a sufficient resistivity not to alter the optical operation of the MIM structure and a TCR for example between about 1% and 5%, unlike a thermometric material corresponding to Ti, Pt or lanthanum manganite which have a too low resistivity, lower than about 0.1 Ohm·cm. Moreover, the aforementioned exemplary materials for the thermometric material 116 are transparent or of weakly absorbing to the wavelengths intended to be detected by the bolometric detector 100, and have a strong temperature coefficient and a small low frequency noise. Depending on the nature of the thermometric material 116, its thickness is for example between about 50 nm and 200 nm.

In this first embodiment, the thickness, or height, e of the empty space 110 does not intervene in the absorption efficiency of the bolometric detector 100. Thus, this thickness e can be of any value, but at least such that the membrane 104 and the substrate 102 be spaced apart by a distance sufficient to prevent a contact between them because of mechanical and electrostatic stresses that can be undergone by the membrane 104. This thickness e can also be adjusted so as to limit the parasitic absorption from the thermally insulating arms 106 and the contact regions formed by the portions of the electrically conductive layer 124 in contact with the thermometric material 116. This thickness e is for example between about 1 μm and 5 μm.

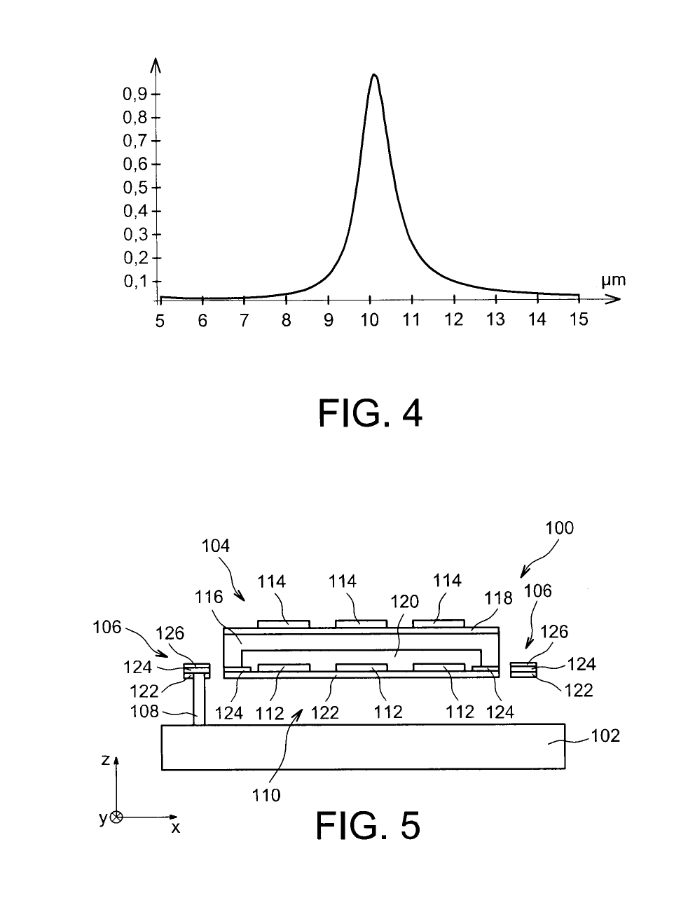

FIG. 4 shows the absorption efficiency as a function of the wavelength, herein about 10 μm, obtained with the previously described bolometric detector 100, including a thermometer material 116 of amorphous silicon with a thickness equal to about 150 nm, metal elements 112 and 114 with a thickness equal to about 100 nm, the upper metal elements 114 each being square-shaped with a side equal to about 1.375 μm and arranged with respect to each other with a period, or pitch, equal to about 2.75 μm (that is made with a fill rate of the area of the membrane 104 in the order of 25%). By adjusting the dimensions and the pitch of the upper metal elements 114 of the MIM structures, it is possible to modify the value of the wavelength for which the absorption made by the detector 100 is maximum, thus enabling multispectral detectors to be made. In FIG. 4, the detection is performed about a wavelength equal to about 10 μm on a width of about 1 μm (for an absorption efficiency of at least 0.5). The detection peak, located at about 10 μm in FIG. 4, can be shifted in a range of values for example between about 2 μm and 16 μm.

Reference will now be made to FIG. 5 which shows a profile cross-section view of the bolometric detector 100 according to a second embodiment.

With respect to the first embodiment previously described, the membrane 104 does not include any lower metal element 112 common to all the MIM structures. Here, each of the MIM structures of the absorber element of the bolometric detector 100 includes a distinct lower metal element 112. Each of the lower metal elements 112 is provided facing one of the upper metal elements 114 and includes herein dimensions, in the plane (X, Y), substantially similar to those of the upper metal element 114 which it faces. The spacing between the lower metal elements 112, that is the pitch of these elements 112, is also similar to that between the upper metal elements 114. Alternatively, the dimensions and/or shape and/or pitch of the lower metal elements 112 could be different from those of the upper metal elements 114. The thicknesses of the lower metal elements 112 are herein similar to each other, and for example of a same value as that of the lower metal element 112 previously described for the first embodiment. Further, portions of the second dielectric layer 120 are arranged between the lower metal elements 112 in order to insulate them with respect to each other. The other elements of the bolometric detector 100 according to this second embodiment are similar to those of the bolometric detector 100 according to the first embodiment.

With respect to a single lower metal element 112 common to all the MIM structures of the absorber element of the bolometric detector 100 as in the first embodiment, the use of several distinct lower metal elements 112 for each of the MIM structures of the bolometric detector 100 according to this second embodiment enables the thermal constant of the bolometric detector 100 to be reduced, however at the expense of a lesser selectivity. Thus, the choice about the structure of the lower metal element(s) 112 is made depending on the requirements to be fulfilled by the bolometric detector 100 as regards the time constant and selectivity searched for.

Moreover, the use of several distinct lower metal elements 112 is not detrimental to the residual absorption obtained given that this configuration allows limiting the regions likely to dissipate the electromagnetic energy received out of the resonance searched for, and allows preventing electrically conductive zones having a high sheet resistance from being exposed to the incident radiation.

Alternatively to the first and second embodiments previously described, the bolometric detector 100 can further include a reflector arranged on the substrate 102, facing the membrane 104, such that the cavity 110 forms a reflective cavity. In this case, the thickness e of the cavity 110 is selected such that the distance between the reflector, corresponding for example to a metal layer arranged on the upper face of the substrate 102, and the or one of the lower metal elements 112 is equal to about λ/2 for the cavity 110 to form a reflective cavity enabling to maximize reflection between the reflector and the membrane 104. Regardless of the embodiment, such a reflective cavity λ/2 is advantageous.

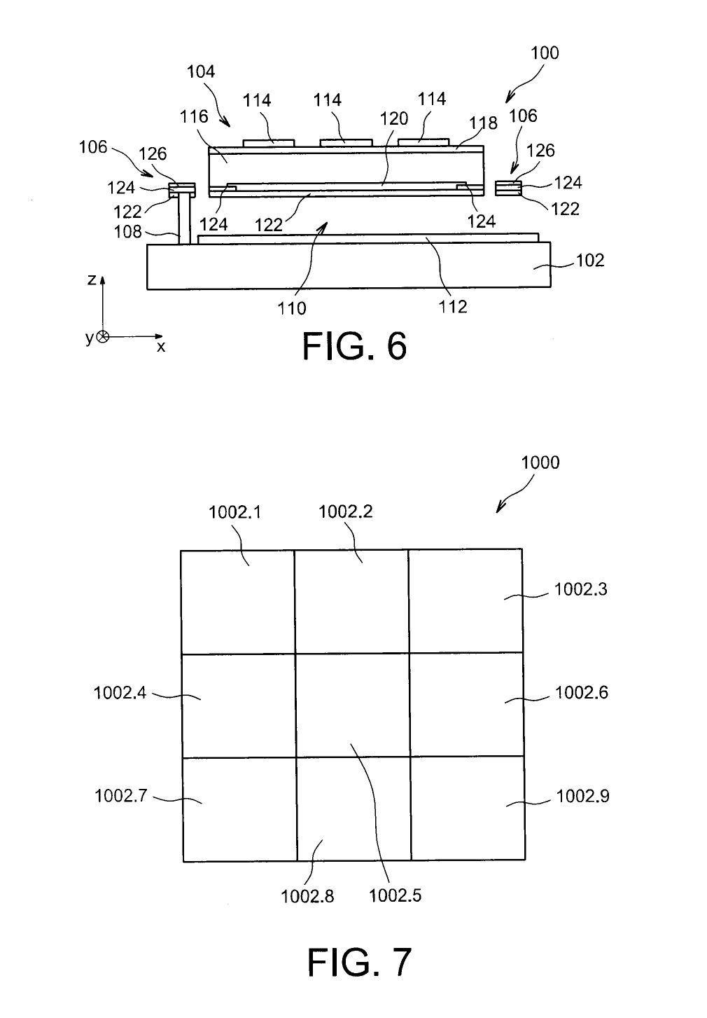

FIG. 6 shows a profile cross-section view of the bolometric detector 100 according to a third embodiment.

As in the first embodiment, a single lower metal element 112 is common to all the MIM structures of the absorber element of the bolometric detector 100. On the other hand, unlike the first embodiment wherein the lower metal element 112 is arranged in the membrane 104 suspended above the substrate 102, the lower metal element 112 is herein arranged not in the suspended membrane 104, but on the substrate 102 such that the cavity 110 is formed between the lower metal element 112 and the membrane 104. In this third embodiment, the MIM structures of the absorber element of the bolometric detector 100 thus each include an upper metal element 114 and the lower metal element 112 (herein common to all the MIM structures). Moreover, the dielectric elements of the MIM structures are formed by the thermometric material 116, the first dielectric layer 118, the second dielectric layer 120 (which alternatively can be omitted), the third dielectric layer 122 as well as the cavity 110. In this third embodiment, the thickness e of the cavity 110 is taken into account in a calculation of the dielectric thickness of the MIM structures, which thickness can be lower or equal to about λ/4 n, or advantageously lower or equal to λ/10 n.

In this third embodiment, the thickness of the lower metal element 112 is selected sufficiently thick to limit the resistive losses therein, and for example such that the resistivity of the lower metal element 112 is at least equal to about 0.1 Ohm/square.

With respect to the first embodiment, this third embodiment has the advantage to decrease the time constant of the bolometric detector 100. Moreover, the bolometric detector 100 according to this third embodiment can be made at lesser coasts because the method implemented to make this bolometric detector 100 follows the process of conventional steps of the methods implemented to make bolometers. Further, with respect to the bolometers of the prior art, a single further lithography level can be made to form the upper metal elements 114.

Alternatively to this third embodiment, several lower metal elements 112, each forming the lower metal element of one of the MIM structures, can be arranged on the substrate 102.

Regardless of the embodiment, the membrane 104 of the bolometric detector 100 is advantageously made as thin films and the thermally insulating arms 106 of the bolometric detector 100 are finely defined to make an efficient thermal insulation of the membrane 104 with respect to the substrate 102 and the electronic circuit formed in the substrate 102. The membrane 102 and the thermally insulating arms 106 are for example made on a sacrificial layer arranged on the substrate 102, preferably of polyimide and of the thickness between about 1 and 5 μm. The thickness of this sacrificial layer corresponds to the thickness e of the cavity 110 which will be formed between the membrane 104 and the substrate 102, and for example equal to about half the wavelength for which the absorption efficiency of the bolometric detector 100 is maximum when a reflector is present on the substrate 102 in order to form a reflective cavity under the membrane 104. In the case of the third embodiment, the lower metal element 112 is formed on the substrate 102 prior to the sacrificial layer which is then deposited by covering the lower metal element 112.

The thin dielectric films of the membrane 104, that is the first dielectric layer 118, the second dielectric layer 120 and the third dielectric layer 122, are for example made by low temperature depositions such as depositions by sputtering or plasma decomposition (PECVD). Etching these layers, implemented after the deposition thereof, can be made by plasma assisted chemical etching.

The electrically conductive layer 124 is made via deposition, for example by sputtering and then structured by etching, for example a chemical etching or a plasma etching.

The thermometric material 116 is for example deposited at a low temperature, for example by sputtering, thermal (LPCVD) or plasma (PECVD) decomposition. The possible doping of the thermometric material 116 is made by introducing a doping gas (for example BF₃ or PH₃) in the reactor used for the deposition thereof, or ionic implantation. The etching of the thermometric material 116 is generally made by a plasma assisted chemical etching method.

Regardless of the embodiment, several bolometric detectors 100 are advantageously collectively made side by side as an array, each bolometric detector 100 forming a pixel of this detection array.

In each bolometric detector 100, the resistance of the thermometric material varies as a function of the temperature of the scene imaged. But the variations in the scene temperature which are intended to be measured are very low. In order to detect these variations more readily, the electronic circuit integrated to the substrate 102 can include a high gain amplifier or integrator stage in order to amplify the signals outputted by the bolometric detectors 100. In order to increase the reading sensitivity of the bolometric detectors 100, it is possible to derive the invariant fraction of the current measured, corresponding to the background temperature of the scene imaged, in a so-called “thresholding” branch of the detectors, to only send the variable part of the current, corresponding to the variations in the temperatures intended to be measured, to the amplifier or integrator stage of the electronic circuit to avoid to saturate it. For this, a solution can consist in using as a thresholding resistance so-called thresholding bolometers, made from the same materials as those used to make the bolometric detectors 100, possibly thermalized at the temperature of the focal plane and which do not perform a detection of the scene temperature because these thresholding bolometers do not include thermally insulating arms and thus include their membrane thermally connected to the substrate by the support elements.

Further, it is possible that an array of bolometric detectors 100 is formed by several sub-arrays each including one or more bolometric detectors 100 such as previously described, these bolometric detectors including MIM structures having different dimensions and/or shape from a sub-array to the other such that each sub-array is able to perform a detection of a range of wavelengths different from those able to be detected by the other sub-arrays, thus forming a multispectral detection array.

FIG. 7 schematically shows a part of a detection device 1000 including a multispectral detection array.

This multispectral detection array includes eight sub-arrays 1002.1 to 1002.4 and 1002.6 to 1002.9 each including one or several bolometric detectors 100 such as previously described. In the example described herein, each of these sub-arrays 1002.1 to 1002.4 and 1002.6 to 1002.9 includes n*n bolometric detectors arranged as a square array, with n integer between for example 1 and 10. Each of the sub-arrays 1002.1 to 1002.4 and 1002.6 to 1002.9 is able to perform a detection of a range of wavelengths defined by the parameters (dimensions, shape, pitch) of the MIM structures of the bolometric detectors of each sub-array.

In the example of FIG. 7, the detector(s) of the sub-array 1002.5 act as a reference to the bolometric detectors of the other sub-arrays 1002.1 to 1002.4 and 1002.6 to 1002.9. The detector(s) of the sub-array 1002.5 are not sensitive to the radiation received by the detection device 1000, for example by making this (these) detector(s) such that it (they) does (do) not include a MIM structure as the bolometric detectors of the other sub-arrays. Thus, by subtracting the value(s) of the signal(s) outputted by the detector(s) of the sub-array 1002.5 from the values of the signals outputted by the bolometric detectors of the other sub-arrays, it is possible to remove the common mode present in the signals outputted by the detectors of the other sub-arrays 1002.1 to 1002.4 and 1002.6 to 1002.9.

Moreover, one or more of the sub-arrays 1002.1 to 1002.4 and 1002.6 to 1002.9 can include so-called thresholding bolometers as previously described.

Regardless of the embodiment, the dimensions of the bolometric detectors 100 are a function of the size of the pixel intended to be formed by the bolometric detectors 100.

1. A bolometric detector including at least:
a substrate;
a membrane suspended above the substrate by support elements;
an absorber element comprising at least one MIM structure formed by a lower metal element, an upper metal element and a dielectric element arranged between the lower metal element and the upper metal element;
a thermometer element comprising at least one thermometric material;
wherein the membrane includes at least the upper metal element of the MIM structure and the thermometric material, and wherein the thermometric material is part of the dielectric element of the MIM structure.

2. The bolometric detector according to claim 1, wherein the thermometric material includes an electrical resistivity higher than about 0.1 Ω·cm and a permittivity a value of the real part of which is positive and a value of the imaginary part of which is lower than about 20% of that of the real part at a wavelength for which the absorption efficiency of the bolometric detector is maximum.

3. The bolometric detector according to claim 1, wherein a distance between the lower metal element and the upper metal element is lower than or equal to λ/(4 n), with λ corresponding to a wavelength for which the absorption efficiency of the bolometric detector is maximum and n corresponding to the actual refractive index of the MIM structure.

4. The bolometric detector according to claim 1, wherein the membrane includes the lower metal element of the MIM structure.

5. The bolometric detector according to claim 4, further including a reflector arranged on the substrate, and a reflective cavity formed between the reflector and the lower metal element of the MIM structure such that a distance between the reflector and the lower metal element of the MIM structure is equal to about half a wavelength for which the absorption efficiency of the bolometric detector is maximum.

6. The bolometric detector according to claim 1, wherein the lower metal element of the MIM structure is arranged on the substrate such that an empty space being part of the dielectric element of the MIM structure is arranged between the membrane and the lower metal element.

7. The bolometric detector according to claim 1, wherein the membrane further includes a first dielectric layer electrically insulating the upper metal element from the thermometric material, and a second dielectric layer electrically insulating the thermometric material from the lower metal element, and wherein the first dielectric layer and the second dielectric layer are part of the dielectric element of the MIM structure.

8. The bolometric detector according to claim 1, wherein the absorber element includes several MIM structures each including an upper metal element distinct from the upper metal elements of the other MIM structures, and wherein the thermometric material is common to the MIM structures.

9. The bolometric detector according to claim 8, wherein each MIM structure includes a lower metal element distinct from the lower metal elements of the other MIM structures, or wherein the MIM structures include a lower metal element common to all the MIM structures.

10. The bolometric detector according to claim 1, wherein the thermometric material is electrically connected to an electronic circuit of the substrate by at least one electrically conductive layer of the membrane and by the support elements.

11. The bolometric detector according to claim 1, wherein the membrane is mechanically and electrically connected to the support elements by thermally insulating arms.

12. A thermal detection device including several bolometric detectors according to claim 1, said bolometric detectors being arranged as an array.

13. The device according to claim 12, wherein the bolometric detectors are arranged by forming several sub-arrays, the bolometric detectors of each of said sub-arrays being able to detect a range of wavelengths different from those intended to be detected by the bolometric detectors of the other sub-arrays.

14. The device according to claim 12, wherein the array includes at least one thresholding bolometric detector including a membrane suspended above the substrate and thermally connected to the substrate.

15. The device according to claim 12, wherein the array includes at least one reference bolometric detector not including a MIM structure.
